(19) United States
(12) Patent Application Publication
(10) Pub. No.: US 2025/0139855 A1
(43) Pub. Date: May 1, 2025

(54) HIGH DEFINITION MAP BUILDING

(71) Applicant: TuSimple, Inc., SAN DIEGO, CA (US)

(72) Inventors: Ke XU, San Diego, CA (US); Thomas Datong WANG, Sunnyvale, CA (US); Hsin LU, San Diego, CA (US); Bolun ZHANG, San Diego, CA (US); Adan Daniel ARTEAGA ORGANIZ, Chula Vista, CA (US); Shicong MA, San Diego, CA (US); Tu Thanh TRAN, San Diego, CA (US); Shenchao ZHANG, San Diego, CA (US); Jinjian ZHAI, Union City, CA (US); Wan-Ting HUNG, Dublin, CA (US); Anping WANG, San Diego, CA (US)

(21) Appl. No.: 18/930,899

(22) Filed: Oct. 29, 2024

Related U.S. Application Data
(60) Provisional application No. 63/594,891, filed on Oct. 31, 2023.

(51) Int. Cl. G06T 11/20

(52) U.S. Cl. CPC G06T 11/206

(57) ABSTRACT

A computer-implemented method of map data processing, comprising generating, for a grid-based representation of map data, raw grid features; building a grid map by reading from a memory that stores the raw grid features; and processing the grid map using one or more post-processing operations including a smoothing operation applied across zero or more grid lines of the grid map according to a rule.

### CROSS-REFERENCE TO RELATED APPLICATIONS

This application claims priority to and the benefit of U.S. Provisional Application No. 63/594,891, filed on Oct. 31, 2023. The aforementioned application of which is incorporated herein by reference in its entirety.

### TECHNICAL FIELD

This document describes techniques for predicting object trajectories in a scene.

### BACKGROUND

In computer-assisted vehicle driving such as autonomous driving, the vehicle moves from a current position to a next position by using information processed by an on-board computer. Users expect the computer-assisted driving operation to be safe under a variety of road conditions. To enable safe driving, a vehicle should be aware of topographical features in its surrounding area.

### SUMMARY

Various embodiments disclosed in the present document may be used to build map data.

In one example aspect, a method of map data processing is disclosed. The method includes generating, for a grid-based representation of map data, raw grid features, building a grid map by reading from a memory that stores the raw grid features, and processing the grid map using one or more post-processing operations including a smoothing operation applied across zero or more grid lines of the grid map according to a rule.

In yet another aspect, an apparatus is disclosed. The apparatus comprises one or more processors configured to implement any of above-recited method.

In yet another aspect, a computer storage medium having code stored thereon is disclosed. The code, upon execution by one or more processor, causes the processor to implement a method described herein.

The above and other aspects and their implementations are described in greater detail in the drawings, the descriptions, and the claims.

### BRIEF DESCRIPTION OF THE DRAWINGS

FIG. 1 shows a block diagram of an example vehicle ecosystem for autonomous driving technology according to some embodiments of the present document.

FIG. 2 is a workflow of a map building operation.

FIG. 3 shows example operations of grid map generation and post-processing.

FIG. 4 shows examples of 2.5D and 3D grid maps.

FIG. 5 is a flowchart of an example map generation operation.

FIG. 6 shows an example of a 3-stage process of building map data.

FIG. 7 depicts an example of raw sensor data processing for map generation.

FIG. 8 shows an example of map data divided into units and grids.

FIG. 9 depicts an example of neighboring units of map data.

FIG. 10 shows an example of a smoothing operation.

FIG. 11A is a block diagram of an example implementation of a bag manager.

FIG. 11B is a block diagram of an example implementation of a pose manager.

FIG. 12A is a block diagram of an example implementation of a content patch generator.

FIG. 12B is a block diagram of an example implementation of a map manager.

FIG. 13 is an example flowchart of a method for map data processing.

### DETAILED DESCRIPTION

Section headings are used in the present document for ease of cross-referencing and improving readability and do not limit scope of disclosed techniques. Furthermore, various image processing techniques have been described by using examples of self-driving vehicle platform as an illustrative example, and it would be understood by one of skill in the art that the disclosed techniques may be used in other operational scenarios also (e.g., video games, traffic simulation, and other applications where map data is used).

### 1. Initial Discussion

Autonomous vehicles rely on map information in path planning and vehicle navigation. Typical map information may include information that remains relatively unchanged (static) over long durations of several weeks or months or may include information that changes on a short-time basis and without notice. For example, diversion paths are provided to re-route traffic during road closures, or some landmark buildings or other objects may appear or may be taken down in a given geographic location. Therefore, the ability to collect map information, generate maps and keep maps up-to-date based on topographical changes is useful to support navigation of autonomous vehicles.

At the same time, building and maintaining map information provides a dauting challenge to computer systems due to the amount of information that may need to be processed. Autonomous vehicles travel at high speeds and cover long distances of upwards of hundreds of miles and therefore may need access to maps of a large geographic region. The volume of data for such a geographic expanse could run into terabytes of data that may need to be frequently accessed and updated. Without careful planning and implementation of a technical solution that streamlines these tasks into simpler, smaller tasks that are selectively performed when needed, map data may become stale or corrupt and it may become difficult to rely on map data for real-time operations.

The present document provides technical solutions that address the above-discussed technical issues with map data, among other problems. In one example aspect, map data processing is divided into a number of smaller tasks by logically partitioning maps into grid cells or patches that are individually updated or built. In another example aspect, the present document also provides some pre-processing or post-processing technique that ensure that such a divide-and-conquer strategy of piecewise map building does not end up creating undesirable artifacts. To this end, the present document provides pose correction and smoothing operations, as further described in the present document.

### 2. Example Vehicle Ecosystem for Autonomous Driving

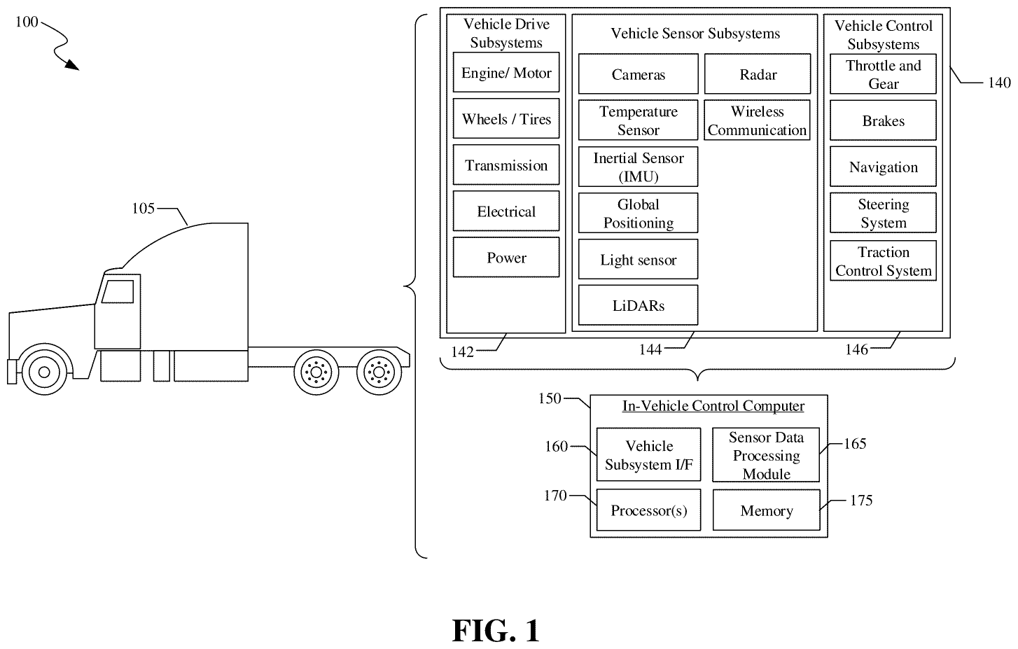

FIG. 1 shows a block diagram of an example vehicle ecosystem 100 for autonomous driving LiDAR technology. The vehicle ecosystem 100 may include an in-vehicle control computer 150 is located in the autonomous vehicle 105. The sensor data processing module 165 of the in-vehicle control computer 150 can perform signal processing techniques on sensor data received from, e.g., one or more of a camera, a light detection and ranging (LiDAR) sensor, a positioning sensor, a radar sensor, an ultrasonic sensor, or a mapping sensor, etc., of (e.g., on or in) the autonomous vehicle 105 so that the signal processing techniques can provide characteristics of objects located on the road where the autonomous vehicle 105 is operated in some embodiments. The sensor data processing module 165 can use at least the information about the characteristics of the one or more objects to send instructions to one or more devices (e.g., motor in the steering system or brakes) in the autonomous vehicle 105 to steer and/or apply brakes.

As exemplified in FIG. 1, the autonomous vehicle 105 may be a truck, e.g., a semi-trailer truck. The vehicle ecosystem 100 may include several systems and components that can generate and/or deliver one or more sources of information/data and related services to the in-vehicle control computer 150 that may be located in an autonomous vehicle 105. The in-vehicle control computer 150 can be in data communication with a plurality of vehicle subsystems 140, all of which can be resident in the autonomous vehicle 105. The in-vehicle computer 150 and the plurality of vehicle subsystems 140 can be referred to as autonomous driving system (ADS). A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The autonomous vehicle (AV) 105 may include various vehicle subsystems that support the operation of the autonomous vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems. Alternatively, in some embodiments, one or more components or devices can be removed from the various subsystems. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment in which the autonomous vehicle 105 is operating or a condition of the autonomous vehicle 105. The vehicle sensor subsystem 144 may include one or more cameras or image capture devices, one or more temperature sensors, an inertial measurement unit (IMU), a Global Positioning System (GPS) device, a plurality of light detection and ranging radar LiDARs, one or more radars, one or more ultrasonic sensors, and/or a wireless communication unit (e.g., a cellular communication transceiver). The vehicle sensor subsystem 144 may also include sensors configured to monitor internal systems of the autonomous vehicle 105 (e.g., an O₂ monitor, a fuel gauge, an engine oil temperature, etc.). In some embodiments, the vehicle sensor subsystem 144 may include sensors in addition to the sensors shown in FIG. 1.

The IMU may include any combination of sensors (e.g., accelerometers and gyroscopes) configured to sense position and orientation changes of the autonomous vehicle 105 based on inertial acceleration. The GPS device may be any sensor configured to estimate a geographic location of the autonomous vehicle 105. For this purpose, the GPS device may include a receiver/transmitter operable to provide information regarding the position of the autonomous vehicle 105 with respect to the Earth. Each of the one or more radars may represent a system that utilizes radio signals to sense objects within the environment in which the autonomous vehicle 105 is operating. In some embodiments, in addition to sensing the objects, the one or more radars may additionally be configured to sense the speed and the heading of the objects proximate to the autonomous vehicle 105. The laser range finders or LiDARs may be any sensor configured to sense objects in the environment in which the autonomous vehicle 105 is located using lasers or a light source. The cameras may include one or more cameras configured to capture a plurality of images of the environment of the autonomous vehicle 105. The cameras may be still image cameras or motion video cameras. The ultrasonic sensors may include one or more ultrasound sensors configured to detect and measure distances to objects in a vicinity of the AV 105.

The vehicle control subsystem 146 may be configured to control operation of the autonomous vehicle 105 and its components. Accordingly, the vehicle control subsystem 146 may include various elements such as a throttle and gear, a brake unit, a navigation unit, a steering system and/or a traction control system. The throttle may be configured to control, for instance, the operating speed of the engine and, in turn, control the speed of the autonomous vehicle 105. The gear may be configured to control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

In FIG. 1, the vehicle control subsystem 146 may also include a traction control system (TCS). The TCS may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the autonomous vehicle 105 can be controlled by the in-vehicle control computer 150. The in-vehicle control computer 150 may include at least one processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the autonomous vehicle 105 in a distributed fashion. In some embodiments, the memory 175 may contain processing instructions (e.g., program logic) executable by the processor 170 to perform various methods and/or functions of the autonomous vehicle 105, including those described for the sensor data processing module 165 as explained in this patent document. For example, the processor 170 of the in-vehicle control computer 150 and may perform operations described in this patent document.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 may control the function of the autonomous vehicle 105 based on inputs received from various vehicle subsystems (e.g., the vehicle drive subsystem 142, the vehicle sensor subsystem 144, and the vehicle control subsystem 146).

Various techniques for generation and maintenance of map, disclosed in the present document, may be implemented using either one or more processors on the above-described vehicle, or may be performed at an offsite facility that supports receiving sensor data from multiple vehicles and downloading map updates to the multiple vehicles.

As further disclosed throughout the present document, the various techniques described in the present document may be used for map data processing in three stages. In the first stage, raw grid features are generated from sensor data. The raw grid features are generated responsive to the grid-structure used for map data processing and storage. In the second stage, a grid map is built by reading the raw grid features from a storage and assembling or building the grid map according to the raw grid features. In the third stage, ad hoc post processing is performed on the grid map. The post-processing includes a smoothing operation that, responsive to the need for the smoothness operation, performs the smoothing operation either within a grid cell or across one or more grid lines. Various example implementations of each of the stages and operations performed therein are disclosed in the following sections and throughout the present document.

### 3. Example Workflows for Building Maps

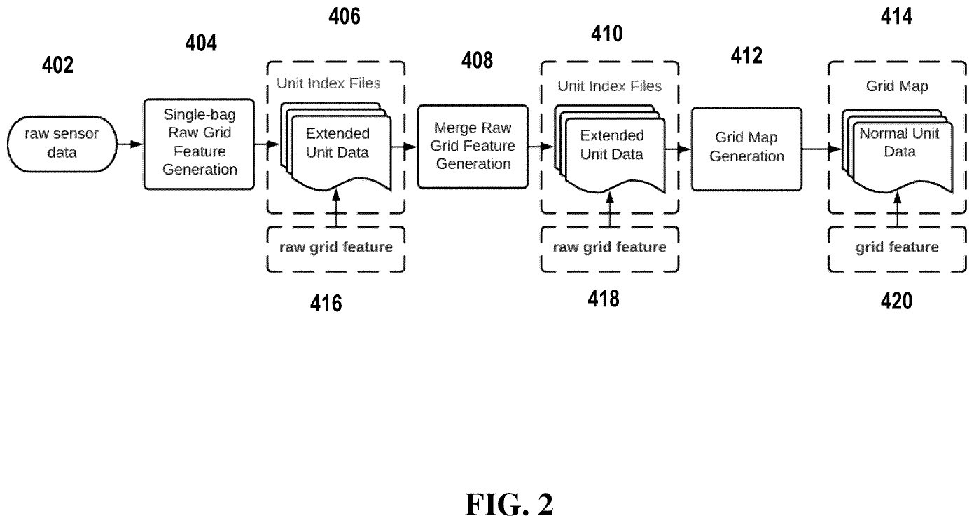

FIG. 2 illustrates and example of the grid map generation pipeline. At 402, raw sensor data is obtained. The raw sensor data may come from lidar sensors and/or cameras fitted on an autonomous vehicle or a survey vehicle that may be manually driven for refreshing map data. At 404, the raw sensor data may be analyzed to generate features from the raw sensor data. For example, this processing may be a single bag processing such that data obtained in one run, which may be stored in a single bag file. The raw grid features extracted from this analysis (416) are used as an input to generate, at 406, unit index files that produce extended unit data that is indexed according to raw features. For example, raw grid features may include streets, lanes, landmarks, and so on. The process of merging existing files with new raw grid features may be repeated separately for each raw grid feature, as indicated by raw grid feature 418, stage 410 and stage 412. The processing unit used for the stages 406 and 410 may us “extended unit data” as is described in the present document. The result of this operation may produce a grid map 414 that includes grids made up of normal data units and grid features 420 associated therewith.

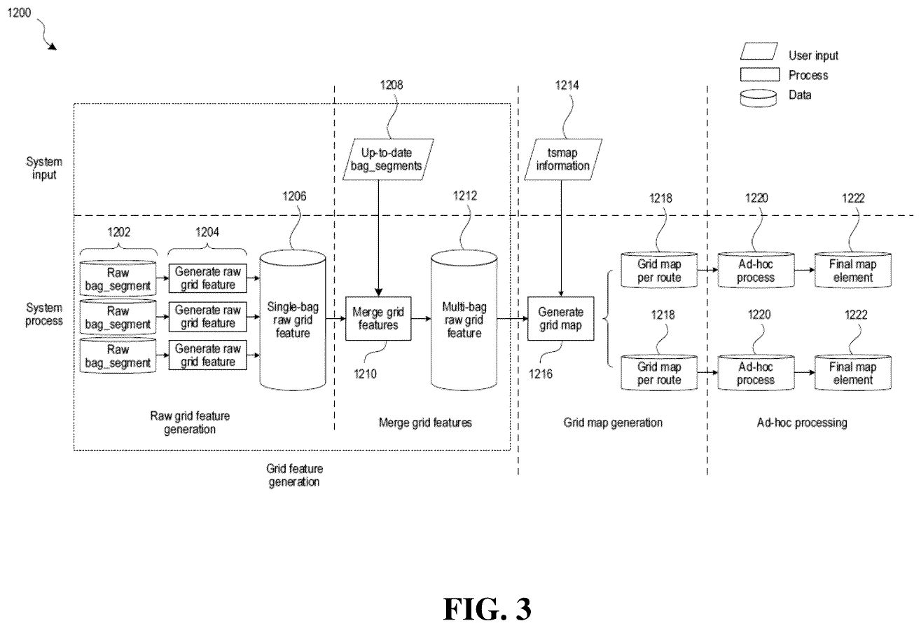

FIG. 3 shows a workflow 1200 in which map building is performed using user input. Here, the top portion shows input provided by a user in terms of identifying up-to-date bag segments (1208) and providing tsmap information (1214). In the flow of processing performed by the map building system, raw bag segments that include raw sensor data are processed at 1202, followed by generation of raw grid features 1204. Next, single bag raw grid features are assembled in database 1206. The up-to-date bag segments 1208 provided by the user are then merged with features extracted by the system to obtain merged grid features 1210. These are stored in a database as multi-bag raw grid features 1212 because, here, these features are a collection of multiple map observation runs. The multi-bag features 1212 are used together with user input of tsmap 1214 to generate a grid map 1216. In some embodiments, the grid map may be split into different units of grid map per route (1218) of travel taken by a vehicle. Next, ad hoc post processing may be applied to each of the grid maps (1220), resulting in a final map element 1222 to be used for future navigation and other tasks.

### 4. Examples of Grid Map Generation Workflows

A grid map represents the world by partitioning the world into discretized fixed size grid cells which each contain localized geometry and/or statistical features. In various embodiments, two different types of grid maps: 2.5D Grid Map and 3D Grid Map may be used.

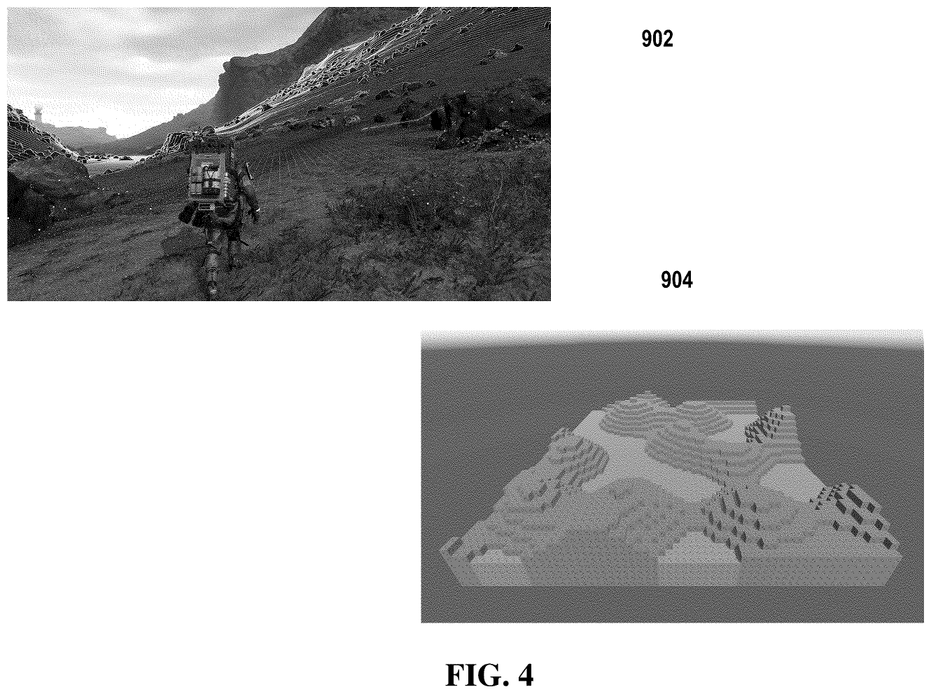

FIG. 4 are examples for 2.5D and 3D grids. View 902 shows an example of a 2.5D grid frame, while view 904 shows an example of a 3D grid.

A 2.5D Grid Map represents the vehicle driving surface (mostly perpendicular to the gravity) into discretized fixed size grid cells. In the map, the 2.5D grid map is used for representing various features from different levels of abstraction within a single grid, e.g., ground height observations (physical), probability of semantic features (semantic), probability of occupancies over the time (prior), etc. Normally referred to by its name, the 2.5D grid map provides a mapping grid index (x, y)|->features, but in the case of multi-layer structure (like overpass), the mapping then is generalized into grid (x, y)|->list of features for each layer. Accordingly, the grid map will sometimes be called a 2.5D map because of the partial 3D characteristic.

A 3D Grid map represents all the features in the 3D space. Unlike the 2.5D Grid map, the 3D map makes no assumptions of the xyz-axis and implies nothing about gravity. It can be viewed as a pure representation of 3D cartesian space disregarding any human defined topology.

The Grid map provides a different view of the real world by representing density, probability and statistics for a certain discretization of space. Compared with vector elements, it provides a method to characterize “shapeless and intangible” elements. It's inherently probabilistic to:
1) represent and accumulate statistics in a certain discretized space by observations over time, e.g., prior maps for probability of long-/short-term static objects
2) derive separations of multiple concentrations of probabilistic mass (gaussian mixture), e.g., softbound for separating paved and unpaved area.

The various sections in the present document disclose, among other things, various additional features and techniques that may be incorporated within these methods. The present document also discloses apparatus for implementing the above discloses methods. The present document also discloses computer-storage medium for storing code that, upon execution, causes at least one processor to implement these methods.

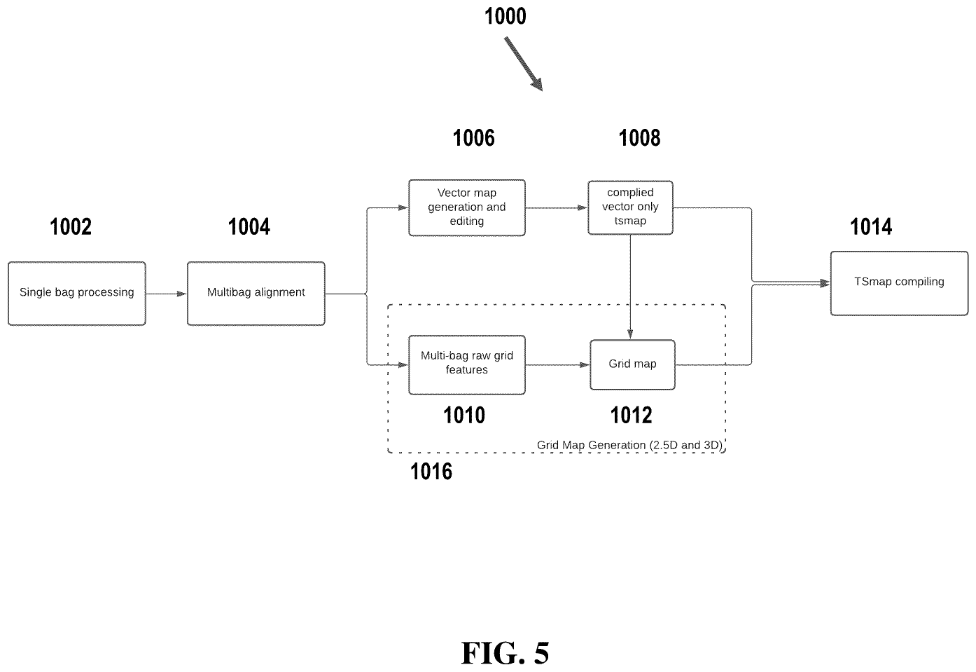

FIG. 5 illustrates an example of a workflow 1000 for map generation. In the map making workflow 1000, the grid map generation 1016 is after the single bag process (1002) and multiple bag optimization (e.g., multibag alignment 1004). The inputs to grid map generation are: 1) sensor observations and corresponding deep learning results generated and stored per frame, and 2) vehicle pose optimized to be aligned with other bags observation. In the workflow 1000, single bag processing 1002 may be performed initially, as disclosed in the present document. The output of this processing may be input to the multibag alignment 1004 operation where grids or patches of different bags of map data may be aligned. The alignment may be performed using an automated tool or through human feedback. The output of the multibag alignment 1004 is processed by the vector map generation and editing stage 1006 that provides input to the vectors-only ts map generation stage 1008. The output may also be processed through the multi-bag raw grid features stage followed by generation of the grid map (102) using the tsmap. The outputs of stage 1008 and 1012 are input to the tsmap compiling stage 1014 which generates map data.

Specifically, a renderer such as Potree may be used. A Potree is a free open-source WebGL based point cloud renderer for large point clouds. Although any other equivalent technique may be used, all such techniques are collectively called “Potree” in the present document. The Potree is an intermediate visualization and can be used as another form of 3D grid map.

In some embodiments, the map processing system supports a process of efficiently generating and updating the grid map on a large scale (e.g., continental size maps that span multiple countries). Inputs of whole system include: a list of time synchronized sensor observations (in the form of a list of bag_segments) used to extract grid features, e.g., global positioning system inertial measurement unit GPSIMU, camera image, lidar point cloud, deep learning results, etc., and a vector only tsmap providing coverage, topology and semantic information. Here, tsmap represents a file format used for storing map information.

Dependencies include deep learning modules to classify and label the raw sensor observations, and aligned vehicle pose for multiple bags. Output of the whole system include a grid map that consistently corresponds to the sensor observations and, if applicable, additional representations derived from the output grid map (such as boundaries).

The map processing system is designed by assuming the following. First, the coverage input bag_segments are assumed to be a superset of the expected output grid map coverage. This assumption also states that there are no restrictions of excessive input coverage of extra layers as long as it covers the target area. Next, it is assumed that the input tsmap reflects the correct real world topology and semantics (otherwise there would be no guarantee of the quality). The height information for various layers is not assumed to be encoded into the tsmap at this stage.

The map processing system is able to operate as follows. As an initial build, the system is able to generate grid maps without reliance on any pre-existing grid maps. For expansion of pre-existing grid maps, overage of the pre-existing maps is expanded with more observations. To handle scenarios such as road changes, with a pre-existing grid map, an update is made reflecting the removal of old observations and adding of new observations. Furthermore, embodiments with a pre-existing grid map with the input as an old tsmap, are able to update the grid map corresponding to the new input of the tsmap. Partial and incremental update may also be performed to ensure that only a reasonable number of areas should be affected.

In some embodiments, 2.5D grid map is constrained by layers but the 3D grid map is not. For 2.5D grid map, the system may only output the layer(s) covered by tsmap. In other words, with the input assumption mentioned above, it could happen that the list of bag_segments cover more layers than the tsmap covers. In this case, the system will identify the layers and output corresponding ones.

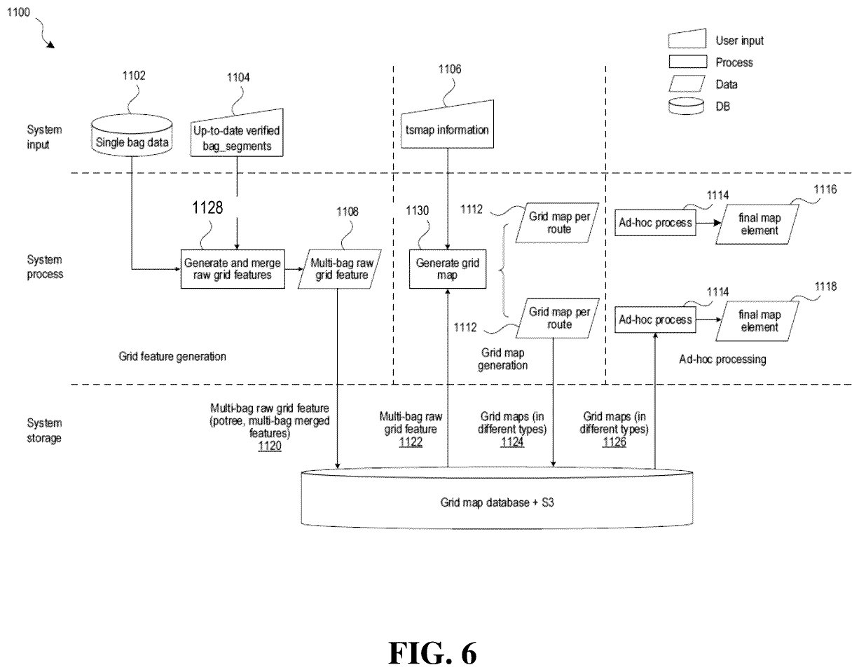

FIG. 6 depicts a 3-stage process 1100 that achieves the above-described features. This process is similar to the process 1200 disclosed with respect to FIG. 3, but also discloses additional features about handling of multi-bag grid maps. Here, input to the map building system include a single bag of data, which includes raw sensor data from one map observation run of a vehicle, up-to-date verified bag segments 1104 and tsmap information 1106. The system generates and merges raw grid features (1128) and generates multi-bag raw grid features (1106). This information is stored as 1120 in the form of multi-bag raw grid features in the grid map database. The tsmap information 1106 provided by the user is used to generate a grid map (1130) together with the multi-bag raw grid features 1120. The grid map may be further processed by splitting into per-route grad map that may be stored in different types (1124) in the database and further be subject to post-processing disclosed in the present document (1114), resulting in final map elements 1116, 1118.

### 5. Raw Grid Features Extraction

This operation may use a grid cell as a unit of processing. A grid cell may correspond to a unit of physical distance (e.g., 0.4 m*0.4 m) and is the smallest unit of the grid map. Each grid cell is a small rectangle in the ll (latitude, longitude) coordinate system, and the grid cell indices are represented as quadkeys. In some embodiments, grid cell dimensions may be adaptable based on terrain for which a map is being drawn. For example, a large dimensional grid cell may be used for map data of geographic locations where fewer geographical changes are expected (e.g., a field or a desert) while a smaller dimension may be used for the grid cell when a large amount of features/feature changes are expected, e.g., urban area.

Embodiments can extract grid features (each grid feature is represented as a vector) from a cluster of sensor points within a grid cell. Embodiments can use the extracted grid features to generate terrain and boundaries further. Using grid features instead of raw sensor points can accelerate the computational speed of both terrain generation and boundary generation. The grid cell size will be the resolution of any features that are generated from the grid features. In some embodiments, the resolution of the grid map will be the size of the grid cell.

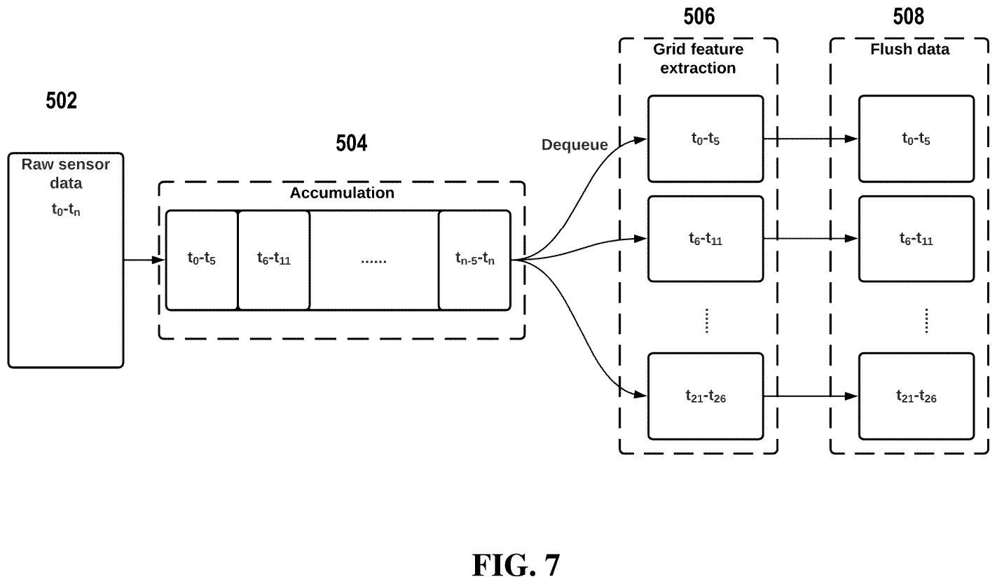

As depicted in FIG. 7, raw sensor data 502 may have time stamp associated with the frames of sensor data (denoted as times to t₀ to tₙ). The raw sensor data is accumulated into a memory buffer according to time intervals. In the depicted embodiments, each accumulated group of frames corresponds to 6 time stamps. The accumulated queue is then dequeued into groups of frames that are processed through a grid feature extraction stage 506. After the grid extraction operation, data is flushed (stage 508).

In the processing depicted in FIG. 7, embodiments may separate the raw data into data blocks for an input data bag segment by merging consecutive frames. Embodiments then extract raw grid features from data blocks concurrently. A raw grid feature contains the topic vector (semantic 3D point segments) and the terrain vector (ground height). Embodiments may first generate the topic label from raw sensor data with deep learning modules while merging frames into the data blocks. Then concurrently, within each data block, embodiments may store all the points within a grid and calculate every grid's terrain and topic vector for every grid.

### 6. Examples of Single Bag Processing

Single bag processing may include transformation from raw sensor data to raw grid features. The resulting data may be stored using an indexing method and/or an application programmers' interface (API) to a database in which the raw grid features are stored.

### 6.1 Single-Bag Raw Grid Feature Generation Examples

As is mentioned in the present document, raw grid feature grid generation is the first step of a grid map generation pipeline. This section provides details of the transformation from raw sensor data (input) to single-bag raw grid features (output). Single-bag raw grid features may also be referred to as raw grid features as a short form. Here, “bag” refers to a commonly used file format for storing map data. Accordingly, single-bag storage may refer to storing map data that is acquired during one run of a surveying vehicle.

The single-bag raw grid feature generation operation aims as a preprocessing module of raw sensor data. Raw sensor data such as images and lidar points contain redundant information. Therefore, this operation aggregates 3d points into grids then extracts and saves high-level features from each grid. Inputs to this process may include a bag segment containing raw sensor observations and vehicle pose for every single frame. In some embodiments, the timestamp of raw sensor observation and vehicle pose may be aligned to provide an accurate estimate of map data.

In some embodiments, deep learning modules may be used to extract semantic information from the raw sensor observations. In some embodiments, deep learning modules to identify and remove moving vehicles that are picked up in the sensor observations.

Outputs of this process may include raw grid features of all grids covered by sensor observations. All observed raw grid features over time, regardless of vehicle, date, segments, etc., may be stored and indexed in a single directory. In other words, raw grid features may be generated from different bag segments separately, but all bag segment outputs are saved within the same directory.

### 7. Examples of Multi-Bag Raw Grid Feature Generation (Stage 1)

The stage works as the following steps. First, all requested single bag data, e.g., raw sensor data and corresponding deep learning results are fetched. Next, the multiple bag data is accumulated and discretized into a grid. The grid includes a number of cells. For each grid cell, statistics and features representations are extracted from the corresponding grid data.

In this stage, a complete list of all the most up-to-date bag_segments are provided. With respect to the list of bag_segments, the system always aggregates all corresponding single bag data and outputs the merged grid feature into a single directory. The single directory applies to all the past and future data regardless of the coverage or routes.

The update of the merged grid feature may be partial and incremental, but the logic may be made transparent to end users. If the state of the merged grid feature is represented by the list of bag_segments generating it, then this level of abstraction can be achieved by introducing the principle of idempotence. The principle states that given all the required single-bag data generated, regardless of the state, identical bag_segments should always yield identical results.

Embodiments of stage 1 may be able to retrieve all required single bag elements and generate grid features by merging observations from several bags. As mentioned previously, idempotence should be guaranteed by the algorithm. In some embodiments, partial and incremental update may be achieved by the algorithm by: keeping records of current state, calculating affected (newly added and/or to be modified) chunks by the difference of the current state and the new state indicated by input bag_segments, retrieving all required single bag observations of the affected chunks, and generating raw grid features by merging observations from several bags.

The data format, file hierarchy and indexes may be defined and managed by the algorithm

Human operators may be able to visualize the current state and remove from or insert to the list of bag_segments with arbitrary length and numbers of new bag_segments. In some embodiments, human operators can only be allowed to use bag_segements verified from the previous stage. This is referred to as multibag pose optimization.

Actual output directory, whether in local disk or cloud file system, made transparent to the algorithm. Grid features can be easily reverted back to any specific version to tolerate bad data/test/human error. This functionality may be supported by data version control.

During an initial build, with no pre-existing merged grid features, using the visualization tool, a human user may build a list of bag_segments, then submit the list to run the map building algorithm. After that the first merged grid features are generated.

With pre-existing grid features (e.g., when updating the map), using the visualization tool, users will load the current state and append new bag_segments to the list, then submit the list to run the algorithm. After that the merged grid features are updated with new coverage.

With pre-existing grid features, when deleting previous features and replacing them with new road features, using the visualization tool, users will load the current state, remove obsolete bag_segments and append new bag_segments to the list, then submit the list to run the algorithm. After that the merged grid features are updated with new coverage.

### 8. Accumulate Road Data

For raw sensor data, data is stored into consecutive frames. Each frame corresponds to a timestamp in the raw sensor data. Consecutive frame data may be accumulated into one data block (accumulated road data). The timestamp of one data block is the timestamp of the last frame within the block. The raw grid feature extraction within each accumulated road data may then be performed.

The following operations may be performed on a single frame of data. A deep learning module may be used to identify and to remove moving objects. Another deep learning module may be used for extracting image segmentations from raw image data (camera coordinate). For pixels in the image, the image point 3D location is obtained by projecting lidar points into camera coordinate. Each image point corresponds to one image semantic label. Another operation performed on a single frame may include similar operations of lidar data points. Lidar segmentations are extracted from raw lidar data (inertial measurement unit imu coordinate) with the deep learning module. Each lidar point corresponds to one lidar semantic label. In general, the image semantic labels are different from the lidar semantic labels). Next operation is to filter both image points and lidar points. Next, all points may be converted to the imu coordinate. Next, an x-y two dimensional bounding plate may be provided to filter all points that are too far from the imu. A z threshold may be provided to separate all points into feature points or ground points. Feature points will be used to generate a topic vector. Ground points will be used to create terrain vector.

An accumulation may be performed for each single frame processed data. Here, embodiments, may accumulate consecutive frame observations with a sliding window into accumulated road data. Each accumulated road data stores the timestamp of the last frame. It may be noted that identical points appearing in continuous frames are stored repeatedly.

### 9. Raw Grid Feature Vector Generation

Because embodiments partition raw sensor data into accumulated road data, which is an physical feature that is independent of the actual sensor details, embodiments can concurrently process the accumulated road data. For a single accumulated road data, the following operations may be performed:
Convert points from imu coordinate to llh coordinate with ecef to llh (latitude-longitude height coordinate) transformation.
Convert points from llh coordinate to grid coordinate. Store all data into corresponding grids. For each grid, the topic feature will be the most three lidar and image labels.

For example, topic feature may be represented as: [img_label1, img_num1, img_label2, img_num2, img_label3, img_num3, lidar_label1, lidar_num1, lidar_label2, lidar_num2, lidar_label3, lidar_num3]
Generate grid height for each grid by calculating the median of all point heights. This height may be in the llh coordinate.

Calculate auxiliary height statistics: average distance of observation, number of points, mean height, mean of square height.

The timestamp, latitude, log of the accumulated road data may also be stored for each frame.

Each grid corresponds to one grid vector and may be represented as a 1×20 list that includes:
timestamp, latitude, longitude, height, average distance of observation, number of points, mean height, mean of square height, img_label1, img_num1, img_label2, img_num2, img_label3, img_num3, lidar_label1, lidar_num1, lidar_label2, lidar_num2, lidar_label3, lidar_num3.

### 10. Storage and Index

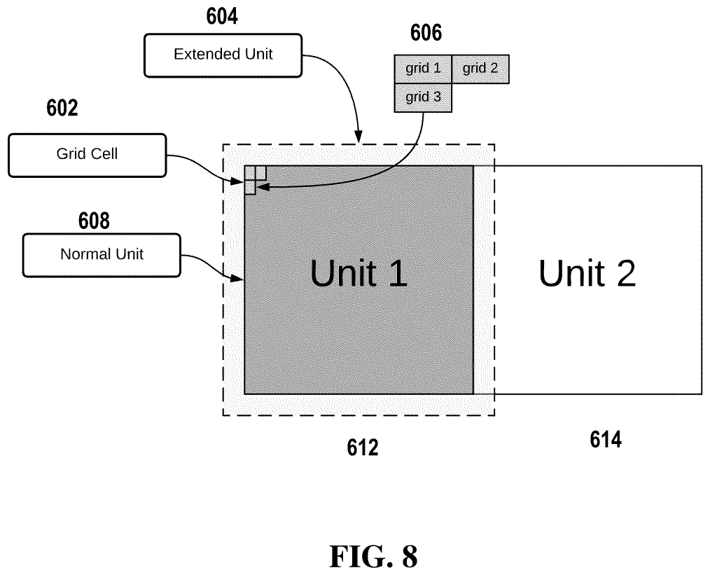

FIG. 8 shows examples of a unit (612, 614) and an extended unit (604) that are used to organize map data for storage and indexing. To assist with map generation, map data is logically divided into data blocks. The term unit refers to a logical internal block that is used data processing. A unit may represent a geographical region, e.g., (10 km*10 km) that contains a large number of grid cells. Each Unit may also be a rectangle in the ll (latitude, longitude) coordinate system, and the Unit indices may be quadkeys, representing four corners of the rectangle. The Unit may be used for storage, partial and incremental grid map updates, and computation acceleration.

As for the final grid map storage, a file (named with the Unit index) may be created for each Unit and the corresponding grid features may be stored into the Unit index file. Thus, the final grid map will be stored in multiple Unit index files. To modify the grid map, only the selected Unit files may have to be changed instead of the entire grid map. Each unit may comprise multiple grid cells 602, e.g., grids 1 to 3 (606) as depicted.

To achieve computation acceleration, e.g., for the merge grid feature module and the grid map generation module, since all data will be stored into Unit index files, each Unit data may be processed with a single (different) processor. However, data discontinuity at the boundary could become a problem when performing concurrent computations based on Units. Hence, we introduce a structure called the Extended Unit. The extended unit may thus provide opportunities to achieve smoothness in the map data after a map is built.

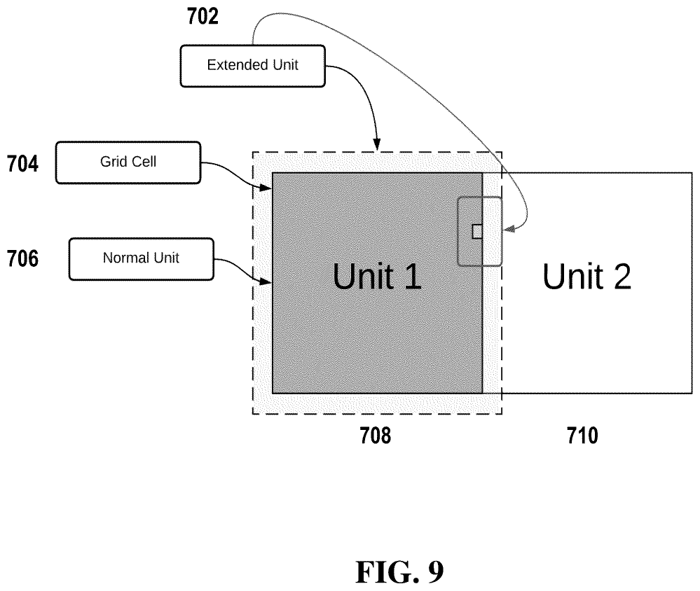

FIG. 9 illustrates an example of an Extended Unit 702 to help with cross-block data processing. In this embodiment, the Extended Unit is a rectangle (slightly larger than the Normal Unit 706) in the ll (latitude, longitude) coordinate system. The Extended Unit 702 index is the same as its corresponding normal Unit index. An Extended Unit 702 is designed to solve data discontinuity and smoothness at the Unit boundaries during multiprocessing. When a map building workflow develops features such as terrain or boundaries, each terrain point or boundary point is generated from a cluster of grid features (e.g., grid cells 704). In the above Unit, the map building workflow can process each Unit's data with a single processor. The prerequisite is to have Unit data independent of each other. But when a map building workflow generates smooth terrain at the Unit boundary, it will also need grid features from the adjacent Unit boundaries. In this case, embodiments can store Extended Unit data instead of Normal Unit data before generating the terrain or boundaries.

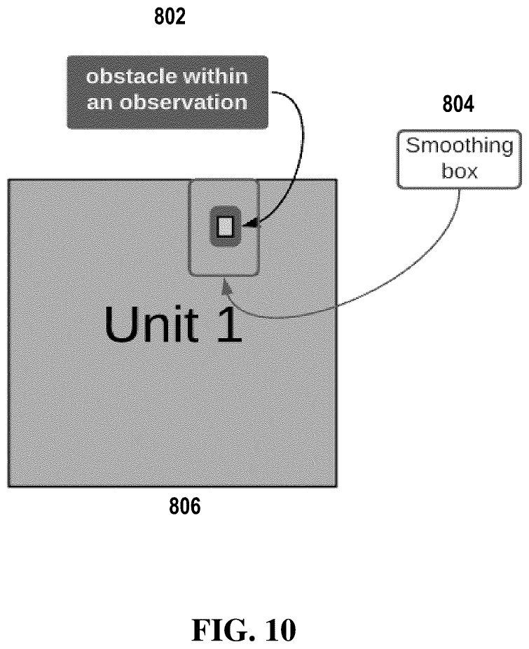

FIG. 10 illustrates an example of raw grid feature and grid feature. In the illustrated embodiment, the raw grid feature is a vector that describes the content of a grid cell calculated from the raw observations within the grid cell. In contrast, the grid feature represents the property of the geographic grid cell. The grid feature is calculated based on raw observations within a large bounding box surrounding the grid cell and the human knowledge. For example, embodiments focus on the consistent geographic information of a grid cell, embodiments will remove temporary obstacles on the ground, such as vehicles and bumps. Embodiments can use a bounding box and a smoothing process to remove the obstacles. Additional examples of the smoothing process are disclosed in Section 15 of the present document.

### 11. Examples of Grid Map Generation (Stage 2)

In this stage, a tsmap containing coverage, topology and semantic information is provided to the system and the system should use the information to generate the grid map.

In this stage, since the concept of “representing the whole continent by a single map” is still in the progress, the 2.5D Grid Map is still associated with the route. Reflected in the organization of grid maps, there should be a master directory for all grid maps with each route stored independently into subfolders.

Iterations of each grid map are subject to the change of tsmap information for a certain route. As the state indicator, which is the tsmap, the principle of idempotence can also be introduced to achieve transparency of partial and incremental update:

Given all the merged grid features generated and unchanged, regardless of the state, an identical tsmap should always yield identical results.

Embodiments may perform the transformation of raw grid features to grid maps according to the techniques described herein. For quality and auditing purpose, embodiments may keep record of the states. For example, some embodiments may achieve partial and incremental updates by specifying a region, based on an input of tsmap (time sequential map) and area (usually represented by closed polygon or geo-indexes) to be updated, and rebuilding the requested area and output the grid map.

In an initial building phase, with no pre-existing grid map, users will input the tsmap and area to run the map-building operation. After that the grid map corresponding to the input tsmap is generated.

In case that the building phase in fact is rebuilding with a pre-existing grid map, users may be able to select the base grid map, then input the new tsmap and area to run the algorithm. After that, the grid map corresponding to the input tsmap is generated.

Similar to stage 1, the principle of idempotence ensures both above operations, if given the same tsmap input, will generate identical results, with the only difference being efficiency.

For a 2.5D grid map, stage 2 infers layers using topological information from tsmap. This step is necessary for the 2.5D grid map because of the specification of the layers. This step is not necessary for the 3D Grid Map.

### 12. Examples of Post-Processing of Grid Map (Stage 3)

Theoretically, after the completion of the above stages, a grid map representing most of the information will have been generated and ready to use. However, some additional post-processing may be performed to facilitate better use of the map. One type of post-processing may be performed to address and compensate for limitations of downstream modules, some ad-hoc processes may be used. Such processes may include Coordinate transformation, reparameterization or ad hoc map editing.

Additional or alternate post-processing may include applying smoothing filter across grid cells to mitigate effects of patching together data that may produce visual and navigational discontinuities. Another post-processing may include compensation for pose of the sensors used to capture the map data.

### 13. Example of Bag Manager

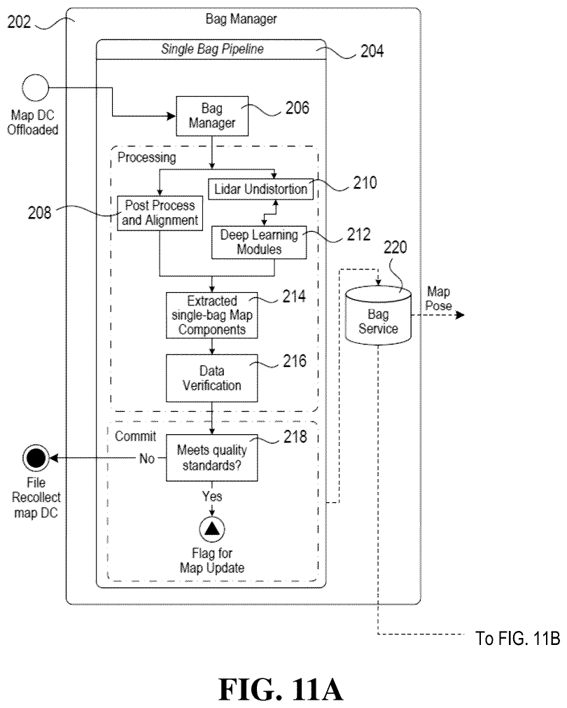

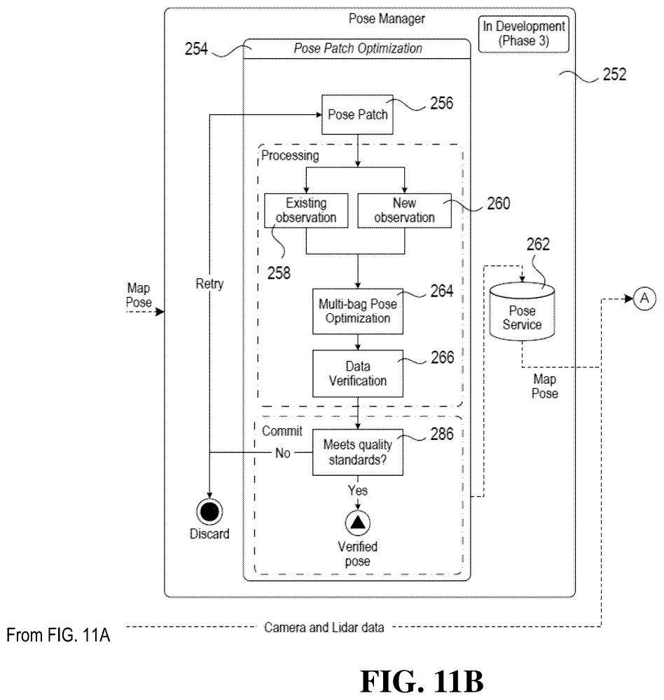

FIG. 11A depicts an example implementation of a bag manager 202. The bag manager 202 may include a single bag processing pipeline 204 in which a bag manager controller 206 receives the map building commands and directs a processing that includes a lidar undistortion operation 210 that performs undistortion of point cloud data obtained from lidar sensors. An output of the undistortion operation 210 is provided to deep learning modules 212 that extracts features from the lidar data. A post processing and alignment operation 208 operates on the raw sensor data to condition the raw data for map generation. For example, post processing may include a smoothing function (e.g., as described in Section 15) that is operated to the raw sensor data. The alignment operation may be performed to remove rotations or other image distortions in the raw image data with respect to a reference pose by performing linear and/or rotational transformation to compensate for the distortion. The reference pose may be, e.g., a pose used in building map data for the same or similar region in a previous map building run. Alternatively, or in addition, the pose may be an absolute reference frame such as a pose specified by a user to which all map data is to conform.

Next, single-back map components may be extracted at operation 214, followed by data verification 216. A check (data verification 216) is made at the output of the data verification 216 regarding whether the generated map data meets a quality standard. In case that the data meets the quality standard, the map data is flagged or earmarked for updating existing map with. In case t hat the data does not meet the quality standard, then this data is discarded, and a future data collection (or recollection) operation may be performed at a future time.

The output of the processing performed by the bag manager 202 may be provided to a bag service 220. Here, the map may be stored in a pre-defined directory structure along with metadata associated with the map data. The metadata may include, for example, time stamp of capture, time stamp of when the processing was performed, whether and how much pose compensation was performed, whether and how much smoothing was generated, various features found in the map data in a searchable format and with associated probabilities of certainty of estimation, and so on. The bag service 220 may provide the map data to map pose manager 252, described next.

### 14. Examples of Pose Compensation

FIG. 11B depicts a block diagram of an example of a pose manager 252 that operates on map data to determine whether a pose mismatch exists and determining the pose mismatch and/or pose compensate the map data. Here, a pose patch optimization (254) may be performed in an iterative manner.

At 256, a pose patch may be generated and applied to a portion of map data (e.g., a grid cell or a patch or another logical region of the map). At 258, the pose patch may be applied to the existing observations or map data (e.g., from previous map data captures). At 260, the pose patch is applied to the new observations that are currently being processed for map building. In some embodiments, the pose patch may be applied to both the new and existing observations. In some embodiments, the pose patch may be applied to only one of the two observations. The resulting pose compensated map data is compared/merged and fed into a multi-bag pose optimization stage 264. Here, map data from multiple bag files is accessed and compared with the result of application of pose patches. The resulting map data is verified at stage 266. If the resulting map data meets a quality standard, as checked in stage 286, the candidate pose is then considered to be suitable for pose compensation and marked as such to the pose service 262 that provides map pose information to external entities. If, on the other hand, at stage 286, it is determined that the pose compensated map data does not meet quality standard, then one or both of the following two actions may be taken. First, it may be decided to discard the pose patch and simply not apply any pose compensation to the map data (which may result in rejecting the map data for map building purpose). Second, a different pose patch may be generated and the above-described operations from 256 to 286 may be performed. The exact way by which the next candidate pose patch is generated may be implementation-specific. For example, in some implementation, a fixed step size may be used to change the offset values of the variables representing coordinate values of pose along six axis (x, y, z, pitch, yaw, roll). In some implementations, a measure of quality may be used in determining how much to change the previous candidate pose patch. For example, when quality is below a first threshold, the pose is discarded. When the quality is above the first threshold but below threshold 2, a step size proportional to quality degradation is applied. When the quality is above threshold 2, a fixed step size may be used.

### 15. Examples of Smoothing Operation

Referring again to FIG. 10, some examples of smoothing operations may be as follows. In general, the smoothing operation may be used to improve usability of map data. The term “smoothing” may refer to reducing variations in one or more attributes of the map data. For example, smoothing may be performed to suppress visual discontinuities that may otherwise be observable to a human eye. Another goal of the smoothing operation is to suppress height variations in the map, which may not be observable by a human eye, but may be experienced by a self-driving vehicle. Yet another goal of the smoothing operation may be to fill in missing map data by reproducing map information based on neighboring temporal and/or neighboring spatial information.

For example, during processing of map data, an obstacle 802 may be detected within observed data. The obstacle 802 may be detected, for example, during feature extraction performed by deep learning on the raw sensor data. Upon detection of the obstacle 802, a decision may be made regarding a smoothing box 804 that represents amount of surrounding (neighboring) information that may be used and/or smoothed to suppress the discontinuity in map data due to the obstacle. In the figure, Unit 1 806 refers to a region of the map data that is used as a basic unit over which the decisions about whether or not to apply a smoothing operation, and how much smoothing to apply, are made.

In some embodiments, smoothing operation may be performed across grid cells. For example, across the boundaries of unit 806 depicted in FIG. 10. Such a smoothing operation may use a lowpass filtering operation to suppress or eliminate any possible discontinuities that may occur across edges of neighboring cells due to slight variations in map data processing such as differences in pose or differences in brightness level etc. Accordingly, in some embodiments, the smoothing operation may be applied across multiple grid cells.

As an example, smoothing may be used when a large vehicle such as a truck, in the angle of view may block raw sensor data collected for map building and obscure features like landmarks or lane markings. In such a case, it may be possible to recreate the missing lane marker based on previous map versions and/or map data from a different observation run for map data building. In this case, the smoothing filter may extrapolate (or interpolate) using adjoining lane marker features into the map data portion that was obstructed by the large vehicle. As another example, map data of two neighboring grid cells or units 806 may have been collected during different environmental conditions such as during different seasons or at different time of days. Due to variation in foliage, angle of the sun, etc., the neighboring grids may be smoothed out using a common intensity value that suppresses the visual discontinuities due to changes in capture situations. Such an adjustment may be performed over multiple consecutive grid cells. Here, the smoothing operation may use a intensity average calculation followed by an intensity re-scaling operation.

### 16. An Alternative for Stage 1

The aforementioned process is based on the assumption that most of the single frame data has been generated and is easily accessible. In the absence of that, stage may perform additional complex tasks such as running deep learning modules. Therefore, in some embodiments, stage 1 is partitioned into 2 sub-stages. The design of these sub-stages strictly follows the same idea as above and once the assumption is satisfied, they can be easily merged.

The first sub-stage mainly fetches raw sensor data, runs deep learning modules and caches grid level statistics. All the features generated in this stage by all segments should be stored and indexed into a single directory consistently. The single directory applies to all the past and future data regardless of the coverage or routes.

In some embodiments, the above-described processing may be executed by taking arbitrary length and arbitrary segmentation of a bag, fetch the raw data and get needed deep learning results, and subsequently generate features. In such embodiments, after a bag is imported into the system, end users will provide an indication of the target segments using a graphical tool and submit the task.

In the second sub-stage, merged grid features may be generated. Given the single bag feature (e.g., cached in the form of grid statistics) and input list of bag_segments, features in the same grid, but from different bags are merged. The same principle of idempotence may also holds.

### 17. Example File Storage Embodiments

In one example embodiment, the following hierarchy of storage may be used: Extended Unit Index->Bag Name->Input Label. Here, the input Label is a manually input string. It indicates the output file is generated through the current execution.

The generation and storage of files for holding map data may include the following operations.

One operations include creating empty folders and files according to the file hierarchy. Here, embodiments may perform initialization of a file for each grid. Additionally, corresponding Extended Unit indices may be calculated. Then, a folder named the unit index may be created under the root folder. Next, a folder named as the bag name may be created under the unit index folder. Finally, a file named as input label (the user will provide this input label) may be created. A grid vector may be appended into the file. For example, each grid vector will be one line in the file. If a raw grid feature locates on the boundary of a unit, this grid vector will be copied and saved into all extended unit files that contain this grid.

Here is an example of calculating all the extended unit indices that the grid belongs to. Suppose a grid vector lat-lon (ll) is [0,0]. Then embodiments will calculate the 8 surrounding lat lon (ll) value based on the extended unit ring value (0.1 for this example):
[[−0.1,−0.1], [−0.1,0], [−0.1,0.1], [0,−0.1], [0,0], [0,0.1], [0.1,−0.1], [0.1,0], [0.1,0.1]]

Embodiments then based on the nine lat lon (ll) values to determine all the extended units to which the current grid vector belongs.

Embodiments may further include an operation to add raw grid features to the corresponding files. This may include Add data to the existing file by first calculating its corresponding extended unit indices. Embodiments may then search for the existing unit index folder, the bag name folder, and the label file. If all exists, embodiments may just append the grid vector into the files. If any folder or file does not exist, embodiments will create a new one (file or folder).

The following techniques may be used for generating and storing file indexes. Within each label file, embodiments will store (unit_idx, ts_begin, ts_end). This will provide the information of [ts_begin, ts_end] indicates the segment and the unit index that indicates the extended units that belong to the following segment (bag name from the parent folder, ts begin, ts end). One reason for using this file hierarchy to save the log information is to avoid conflicts when writing raw grid features into files concurrently. Using this structure, embodiments can find its corresponding raw data file for a given segment with the bag name, label, and unit index. Embodiments can read the log file with the bag name and label. To find the corresponding unit index, embodiments will compare the segment with the timestamp in the label file to search for the unit index.

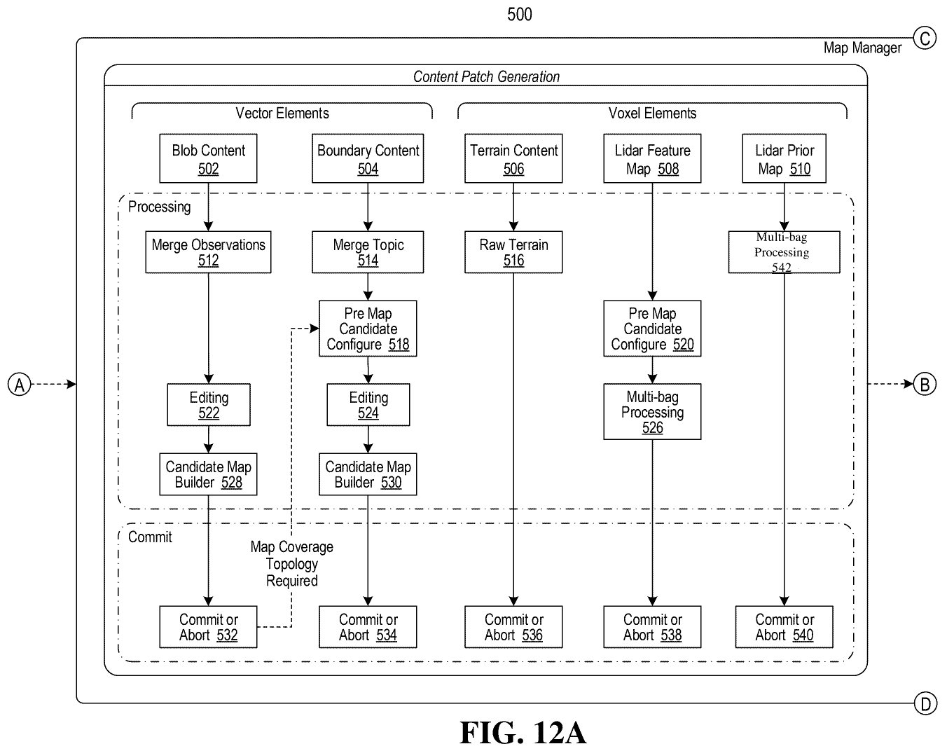

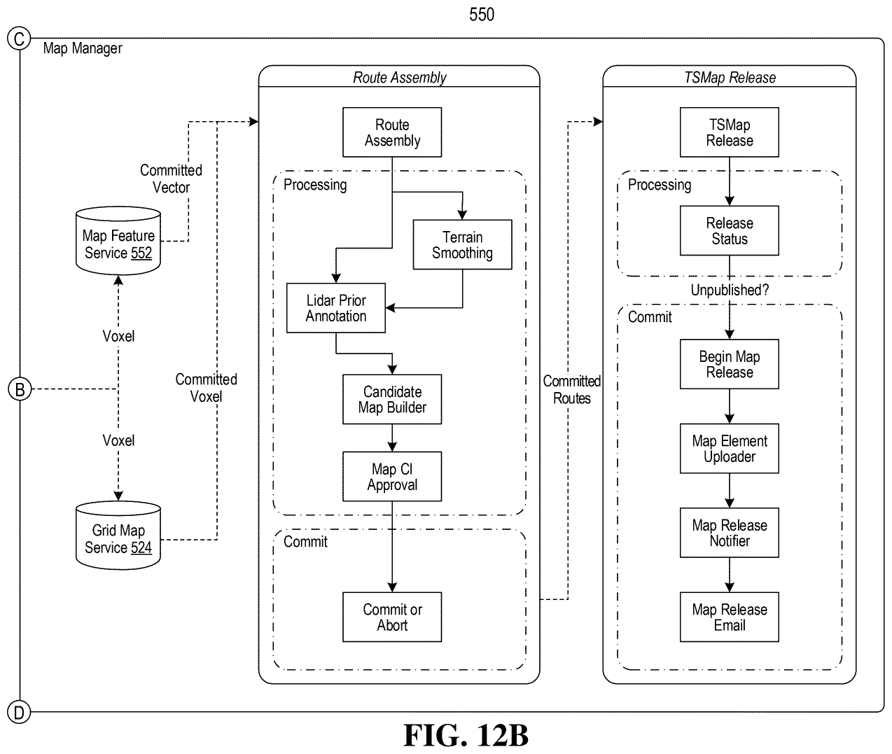

FIG. 12A shows an example workflow 500 of how a content patch is generated and committed to for storage. As described in the present document, the raw sensor data may be processed, and various features may be extracted. Some features may be represented using vector elements and some features may be represented using voxel elements (e.g., 3D features). Vector elements may include description of inside features, e.g., for blob content (502) which may be content from within a potential object, and boundary features 504 of a geographical portion (e.g., lane width and lane boundary). Voxel elements may be, e.g., terrain content 506, lidar map features 508 or previous lidar map features 510 from previous map observation runs. For blob content 502, the observations may be merged (512), edited (528) and input as candidates to a map builder (528). The boundary content 504 may be merged by topic (514) which explains what type of boundary. The boundaries may be configured as map candidate boundaries in a pre-map stage 518, edited 524, and then used as candidates to a map builder 530. The boundary content pre-map configuration 518 may also include an input about which particular map coverage (or map topology) is currently being built. Finally, decisions are made about whether or not to use the resulting blob content (532) or boundary content (534) for content patch building.

From the voxel elements, the terrain content 506 is processed or identified as raw terrain (516) and either committed to map building or removed (536). The lidar map features 508 are used as map candidates 520 and processed through multi-bag processing 526 as described in the present document. Finally, a decision is made about whether to use the results or not (538). The lidar features of previous map (510) are (previously) processed through multi-bag processing 542 and then a decision is made about whether or not to use these features (540) for generating a content patch.

FIG. 12B shows how the map manager uses a content patch produced using the process 500. The received content patch may be split into its vector and voxel portions. The vector information 552 is stored in a map feature service. The voxel information is stored in a grid map service 554. The committed voxels and vectors, that is, the voxel and vector information used for making next map build are then processed through a route assembly routine to be able to present a route map to a vehicle or a user. The route assembly includes terrain smoothing, followed by applying previously known lidar annotations to the new data. Based on this, new candidate map is built and is presented for approval as a new map patch. Upon approval, this information is applied to the new build of the map, otherwise it is rejected from further use. The committed routes are then used as input to a next version of TSmap. Here, release status may be updated. The new map is then released by uploading in smaller quantum (called elements). After the map elements are uploaded for use by interested parties (e.g., fleet vehicles or human users), a notification may be made about availability of a newer version of the map, including, for example, an email to human users of the new release of the map. Section 18 discloses an example of how a system for building a new map or rebuilding (refreshing) a previous map.

### 18. An Example of a System for Building or Rebuilding Maps

In some embodiments, the map building may be performed in a software/hardware system that manages releases of maps using an example workflow as follows: select map->create map release->map building->map validation test->release publish->map upload. This process may be generally called map planning, referring to a human user controlling a computer system to build or rebuild map data.

In some embodiments, an overall map plan, schedule and progress may be presented to the user. Different users may have different levels of authorizations to 1create, delete, query and update plans.

Some embodiments may allow authorized users to create map plans. In various embodiments, a map plan includes map expansion plan (AFN), a map maintenance plan and other attributes related to geographical changes to a region.

Each map that is built may be specified from a user interface using one or more of the following attributes: map name (map feature name), a map type (AFN, maintenance, testing, others), a map description (optional), a start location global position coordinate gps/city/address, an end location gps/city/address, an estimated start date (when the map building was begun), estimated completion date.

After the map plan is created, some or all of the following information may be associated with the map plan: map name (map feature name), map type (AFN, maintenance, others), map description, start location gps, end location gps, mileage, estimated start date, estimated map collection start date, estimated map production start date, estimated map testing start date, estimated completion date (release date), estimated map collection end date, estimated map production end date, estimated map testing end date, map elements included, plan create datetime, last modify datetime, last modify user, plan status.

The created plan may be listed in the order of estimated start date by default.

Embodiments may allow authorized users to delete map plan with the confirmation of users.

Some embodiments may allow authorized users to update map plan information.

Some embodiments may provide the ability to search for a map plan with approximate key words. Some embodiments may provide the ability to filter map plans by one or more filtering criteria, including: map name (map feature name), or last modify user.

Some embodiments may provide the ability to sort map plans by an estimated start date, an estimated completion date or a last modify datetime

Some embodiments may track and update status of each map plan that is stored in the system memory. Some embodiments may update map plan status by synchronizing task assignment status. To simplify case of map management, some embodiments may limit map plans to only have one type of status and following the order of pending—map data collection—map production—map testing—released. Here pending is the default status upon creation, map data collection is the status when map data collection is ongoing, map production is the status when map is being built after the map data collection is over, map testing may be the status when map is being tested before release, and released may mean that the map data is ready to be used in actual driving.

Embodiments may provide a map view in a user interface to allow a user to review all map plans and their status.

Embodiments may also provide the ability to make changes to a map on a patch by patch basis. Here, a patch typically may include one or multiple grid cells. An example workflow may be as follows: select map->create patch->bag selection->patch scheduling->multi-bag pose optimization->grid map generation->map editing->map building->map quality assessment (QA) check->patch commit.

Each patch may be identified by a name and a range of geography covered by the patch (e.g., 3+ location with gps coordinates), bag(s) that contain the data to be used (e.g., a list of bags ordered by time), available elements generated from a bag are listed, required elements (corresponding to required tasks).

The user shall be able to select required map elements after patch range and bag(s) are selected. Embodiments may provide a list of map element options for the user to add as a to-do task

The map clement tasks may include: gpsimu alignment, scanpoint generation, blob generation, speed limit generation, traffic sign generation, poles generation, terrain generation, soft/hard boundary generation, lidar prior map generation, lidar feature map generation, semantic layer map editing, physical layer map editing, map building, map testing.

### 19. Examples of Single Bag Processing Pipeline

Workflow: create bag->apply post processing->pose alignment +lidar segmentation +image segmentation->blob generation->populate bag DB->bag processing completes

The tasks in single bag processing may include scanpoint, deep segmentation, image segmentation mask, lidar segmentation mask, aligned gpsimu, Blobs, Speed limits, Traffic signs, Poles

A bag file that includes map data may be searchable and sortable by associating the following metadata with it: bag name, vehicle name, begin time, duration, Metadata (detailed information), bag name, vehicle name/vehicle version, begin time, end time, duration, docker, map file type, distance, trip ID, description, driver, copilot, Single bag processing status, Result configuration, and so on.

Examples of bag manager

Examples of map manager

Examples of content patch generation

### 20. Examples of Technical Solutions

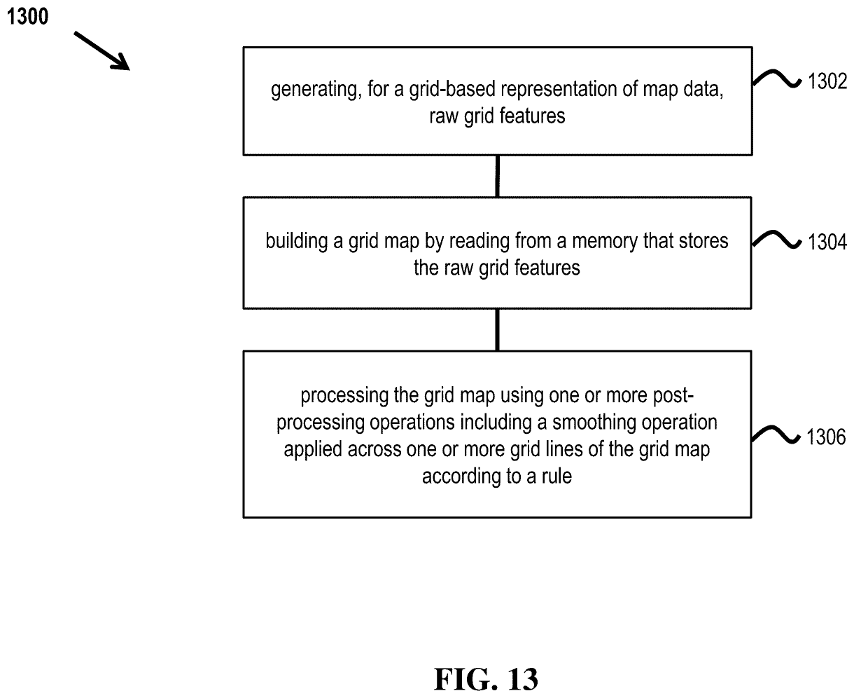

The following technical solutions may be preferably adopted by some embodiments.
1. A computer-implemented method (e.g., method 1300 depicted in FIG. 13) of map data processing, that includes generating (1302), for a grid-based representation of map data, raw grid features; building (1304) a grid map by reading from a memory that stores the raw grid features; and processing (1306) the grid map using one or more post-processing operations including a smoothing operation applied across zero or more grid lines of the grid map according to a rule.
2. The method of solution 1, wherein the raw grid features comprise sensor data from lidar and/or camera sensors, vehicle pose information and semantic information that is derived by operating a deep learning algorithm on the sensor data. Various features of the raw grid extraction process are described in Sections 5 to 11 and with reference to FIGS. 1 to 6 of the present document.
3. The method of solution 2, wherein the raw grid features are stored in the memory in a single directory as multiple file corresponding to different frames of the sensor data.
4. The method of any of above solutions, wherein the raw grid features are generated by performing an alignment operation among map data captured during different capture runs. As described in the present document, the alignment operation may use pose of the sensor used for capturing the map data. Additional features are described in Section 14.
5. The method of any of above solutions, wherein the rule specifies that a number of the zero or more grid lines across which the smoothing operation is performed is proportional to an intrinsic property associated with a texture of the map data. Smoothing operation features are further disclosed in Section 15.
6. The method of solution 4, wherein the rule specifies that a number of the zero or more grid lines across which the smoothing operation is performed is dependent on an amount of alignment applied during the alignment operation. For example, when a greater pose estimation adjustment is performed, a greater amount of smoothing may need to be applied. As another example, is a pose of a sensor is determined to create occlusion of a map feature, then the map feature may be filled in using temporally or spatially neighboring information, thereby resulting in smoothing of map.
7. The method of any of above solutions, wherein the raw grid features comprise 3-dimensional or 2.5-dimensional features.
8. The method of any of above solutions, wherein the one or more post-processing operations include a coordinate transformation operation.
9. The method of any of above solutions, wherein the raw grid features are generated using a deep learning algorithm.
10. The method of any of above solutions, wherein the building the grid map comprises building the grid map on a grid cell by grid cell basis, wherein each grid cell represents a pre-defined amount of geographical distance.
11. The method of solution 10, wherein neighboring grid cells are non-overlapping. One advantage of non-overlapping grid cells is that the amount of computing power needed for building the map may be low.
12. The method of solution 10, wherein neighboring grid cells are overlapping. With overlapping, although total amount of map data that is processed may increase, the overlapped portion allowed for performing smoothing and also parallelizing map building tasks.
13. The method of any of above solutions, wherein the grid map is built according to a state associated with the building; and wherein the grid map is built according to principle of idempotency that states that the grid map is identical irrespective of a value of the state associated with the building. The various states include, for example, sensor poses, time of the day at which map data is observed, whether this is a new map or whether this is an update to an existing map, and so on.
14. The method of any of above solutions, wherein the smoothing operation comprises a smoothing operation due to an obstacle in observed map data. Additional features are disclosed with reference to Section 15 and FIG. 10.
15. An apparatus comprising one or more processors configured to implement a method recited in any of solutions 1-14.
16. A computer-storage medium having process-executable code that, upon execution, causes one or more processor to implement a method recited in any of solutions 1-14.

### 21. Final Remarks

It will be appreciated by one of skill in the art that the present document provides several techniques for building a navigation map that may be used in autonomous driving operations. It will further be appreciated that the map building task is divided into multiple smaller tasks by using a grid based approach. It will further be appreciated that the map building task may be performed in three stages—a first stage in which raw sensor data is analyzed to extract map features, a second stage in which a grid map is built and a third step in which post-processing is performed on the grid map to make it more usable and accurate. It will further be appreciated that, in particular, two processing techniques may be used to make maps more accurate: a first technique in which pose correction is applied to map grids among different map acquisition runs (e.g., different bag files) and a second technique in which a smoothing process is applied to the grid map built from raw sensor observations.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations. enhancements and variations can be made based on what is described and illustrated in this disclosure.

1. A computer-implemented method of map data processing, comprising:
generating, for a grid-based representation of map data, raw grid features;
building a grid map by reading from a memory that stores the raw grid features; and
processing the grid map using one or more post-processing operations including a smoothing operation applied across zero or more grid lines of the grid map according to a rule.

2. The method of claim 1, wherein the raw grid features comprise sensor data from lidar and/or camera sensors, vehicle pose information and semantic information that is derived by operating a deep learning algorithm on the sensor data.

3. The method of claim 2, wherein the raw grid features are stored in the memory in a single directory as multiple file corresponding to different frames of the sensor data.

4. The method of claim 1, wherein the raw grid features are generated by performing an alignment operation among map data captured during different capture runs.

5. The method of claim 1, wherein the rule specifies that a number of the zero or more grid lines across which the smoothing operation is performed is proportional to an intrinsic property associated with a texture of the map data.

6. The method of claim 4, wherein the rule specifies that a number of the zero or more grid lines across which the smoothing operation is performed is dependent on an amount of alignment applied during the alignment operation.

7. The method of claim 1, wherein the raw grid features comprise 3-dimensional or 2.5-dimensional features.

8. The method of claim 1, wherein the one or more post-processing operations include a coordinate transformation operation.

9. The method of claim 1, wherein the raw grid features are generated using a deep learning algorithm.

10. The method of claim 1, wherein the building the grid map comprises building the grid map on a grid cell by grid cell basis, wherein each grid cell represents a pre-defined amount of geographical distance.

11. The method of claim 10, wherein neighboring grid cells are non-overlapping.

12. The method of claim 10, wherein neighboring grid cells are overlapping.

13. The method of claim 1, wherein the grid map is built according to a state associated with the building; and
wherein the grid map is built according to principle of idempotency that states that the grid map is identical irrespective of a value of the state associated with the building.

14. The method of claim 1, wherein the smoothing operation comprises a smoothing operation due to an obstacle in observed map data.

15. An apparatus comprising one or more processors configured to implement a method, comprising:
generating, for a grid-based representation of map data, raw grid features;
building a grid map by reading from a memory that stores the raw grid features; and
processing the grid map using one or more post-processing operations including a smoothing operation applied across zero or more grid lines of the grid map according to a rule.

16. The apparatus of claim 15, wherein the raw grid features comprise sensor data from lidar and/or camera sensors, vehicle pose information and semantic information that is derived by operating a deep learning algorithm on the sensor data.

17. The apparatus of claim 16, wherein the raw grid features are stored in the memory in a single directory as multiple file corresponding to different frames of the sensor data.

18. The apparatus of claim 15, wherein the raw grid features are generated by performing an alignment operation among map data captured during different capture runs.

19. A computer-storage medium having process-executable code that, upon execution, causes one or more processor to implement a method, comprising:
generating, for a grid-based representation of map data, raw grid features;
building a grid map by reading from a memory that stores the raw grid features; and
processing the grid map using one or more post-processing operations including a smoothing operation applied across zero or more grid lines of the grid map according to a rule.

20. The computer-storage medium of claim 19, wherein the raw grid features are generated by performing an alignment operation among map data captured during different capture runs.
